(19) United States
(12) Patent Application Publication
(10) Pub. No.: US 2003/0126605 A1
(43) Pub. Date: Jul. 3, 2003

(54) Method for displaying EPG video-clip previews on demand

(76) Inventors: Steve Craig Betz, Zionsville, IN (US); Herman Paul Haas, Pittsboro, IN (US); Alan Franken, Carmel, IN (US)

Correspondence Address: JOSEPH S. TRIPOLI, THOMSON MULTIMEDIA LICENSING INC., 2 INDEPENDENCE WAY, P.O. BOX 5312, PRINCETON, NJ, 08543-5312, US

(21) Appl. No.: 10/033,317

(22) Filed: Dec. 28, 2001

(51) Int. Cl. H04N 5/445; H04N 7/173

(52) U.S. Cl. 725/39; 725/87

(57) ABSTRACT

An interactive television system designed to populate an electronic program guide (EPG), which provides Video-Clip Previews on Demand by automatically launching a video clip preview, after browsing and navigating through the EPG's grid guide to a highlighted program titled cell, and remaining at such highlighted cell for a predetermined delay. The display process is a “No-Touch Display” process requiring no selections by the viewer while browsing.

### FIELD OF THE INVENTION

This invention relates to interactive television systems, and more particularly to an interactive television system which includes an electronic program guide (EPG) that displays a video clip preview while browsing and navigating through the EPG's grid guide.

### BACKGROUND OF THE INVENTION

Video on Demand (VOD) systems conventionally have a graphical (often HTML) ordering menu that display text based descriptions of a program along with a still picture of a “movie poster”, or some representation of the program content. From the ordering menu, there exists means for navigating to a “button” to activate a request for the program and confirm a desire to spend a particular dollar amount before the program is delivered for viewing. In some cases, from that same ordering menu there exists a “Preview” button next to the “Order” button that executes the VOD delivery of a free preview. However, the program and the free video preview are not linked (logically) in software. Instead, the program and the free video preview are handled as two separate pieces of video content that must be requested and served independently of each other.

The absence of the video preview content on EPG and Personal Video Recorder (PVR) directories is the biggest drawback. Thus, the viewer is provided limited or little information regarding the programming available, and the content owners are provided few means of promoting their content in this media. While video previews of movies and yet to be aired broadcast television programming routinely exist, they are aired during commercial slots. There is no assurance that viewers interested in this content will actually see these commercial slots. Hence, the broadcaster and/or program owner has limited means of marketing their program to potential viewers, and must purchase or allocate many commercial time slots to sufficiently improve the chances that interested viewers will become aware of and interested in their content. The availability of Video Clip Previews on Demand will help raise the viewer's awareness and interest in programming that has yet to be aired in a more cost effective manner that improves the entertainment experience for viewers.

Even when video previews are available, such as in the VOD example, there are some drawbacks in that the viewer must explicitly push buttons to get access to the video previews and then go back to the ordering menu and push more buttons to order the program, which is cumbersome. In view of the foregoing, there is a continuing need for an interactive television system that provides Video-Clip Previews on Demand by automatically launching a video clip preview of a highlighted program title cell of the electronic program guide (EPG), after a predetermined delay, with an assumption that the viewer wants to see the video clip preview, if available, thereby making the shopping, navigating and browsing experience more convenient and enjoyable.

Furthermore, there is a continuing need for an interactive television system that links the video clip preview with its associated “destination content” to further facilitate the viewing, ordering, or recording of the “destination” program, in the present, or in the future.

### SUMMARY OF THE INVENTION

An interactive television system having electronic program guide (EPG) providing Video-Clip Previews on Demand by automatically launching a video clip preview, after browsing and navigating through the EPG's grid guide to a highlighted program titled cell, and remaining at such highlighted cell for a predetermined delay.

### BRIEF DESCRIPTION OF THE DRAWINGS

FIG. 1A shows an electronic program guide according to the present invention.

FIG. 1B shows the electronic program guide according to the present invention displaying the video clip preview.

FIG. 1C shows the full screen video clip preview.

FIG. 2 shows a remote control device of the present invention.

FIG. 3 shows flowchart illustrating the process for displaying video clip previews according to the present invention.

FIG. 4 shows an interactive television or broadcast system according with the present invention.

### DETAILED DESCRIPTION OF THE INVENTION

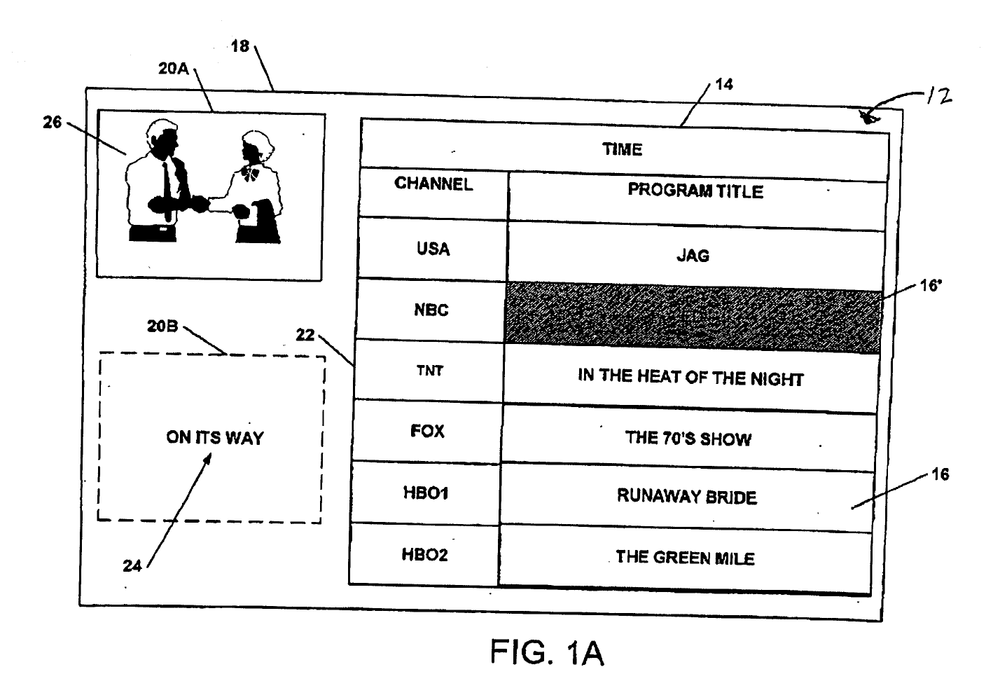

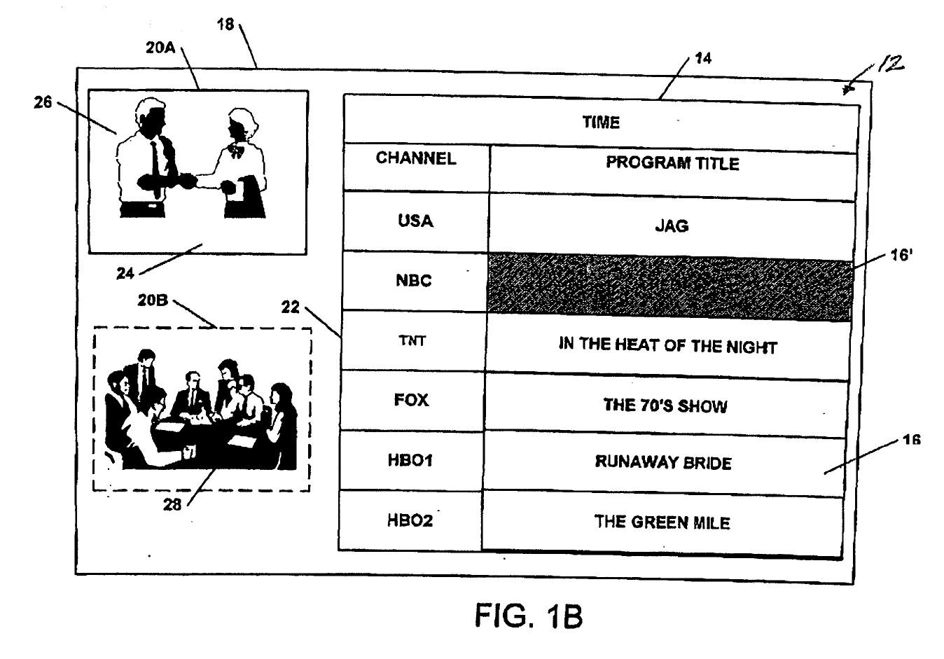

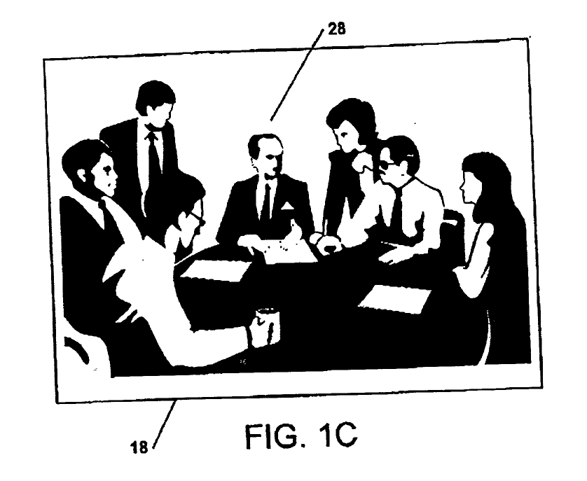

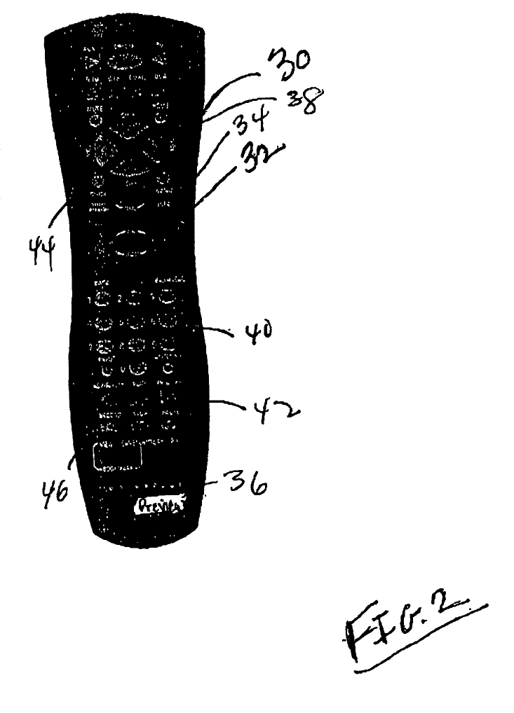

FIGS. 1A and 1B shows an EPG grid guide 14 of an electronic programming guide (EPG) 12 according to the present invention displayed on display screen 18. The EPG grid guide 14 includes a plurality of program titled cells 16 which display the program title of a program of a channel 22 for a displayed scheduled time. While navigating within the EPG grid guide 14, a program titled cell 16′ displaying the program title can be highlighted. By using the up/down/left/right navigation buttons 32 on the remote control device 30 (FIG. 2), the viewer navigates through the EPG grid guide 14 to discover not only what is currently being broadcast, but what programming is scheduled to be broadcast in the near future. Presently, some EPGs store up to 14 days of such future programming. In general, the EPG grid guide 14 illustrated is a single display page and typically includes many pages identifying by time up to 14 days of future programming.

While EPG grid guides 14 have many formats, many EPG grid guides 14 have a smaller display window 20A used to display currently tuned programming wherein the currently tuned programming was displayed on display screen 18 prior to the selection and display of the EPG grid guide 14. Thus, as the viewer navigates and browses the EPG grid guide 14 for upcoming programming, scenes of the currently tuned programming are not necessarily missed. In one embodiment, the display window 20A is used to display a video clip preview 28 when loaded.

In an alternate embodiment, a second display window 20B, shown in phantom, displays the video clip preview 28 simultaneously with the currently tuned programming shown in display window 20A. However the audio track for the video clip preview 28 dominates when the video clip preview 28 is showing. The display windows 20A and 20B function in a similar manner as picture and picture displays, but with different relative scaling of video images, and different graphic composition.

As the viewer navigates and browses through the EPG grid guide 14 and the program titled cell 16′ highlighted, descriptive text, sometimes referred to as “metadata” associated with such program title, is displayed. Likewise, during the viewing of said content, if the viewer makes a selection, such as by pressing the “INFO” button 34 next to the up/down/left/right navigation buttons 32, the same descriptive text, associated with such program title, is displayed.

The remote control device 30 further includes a “Guide” button 44 to launch the EPG 12 on the display screen 18. Furthermore, the remote control device 30 includes channel up/down and volume up/down buttons 38, a numerical keypad 40, VCR control buttons 42 including “Record” button 46. The remote control device 30 also includes other buttons for turning on and off the display screen 18 and for performing other conventional functions. If the program has associated therewith a video clip preview 28, during the playing of the video clip preview 28 or after the playing of the video clip preview 28, the viewer may select a record option. The record option may record a program associated with the video clip preview 28 scheduled to broadcast in the future or at the present time.

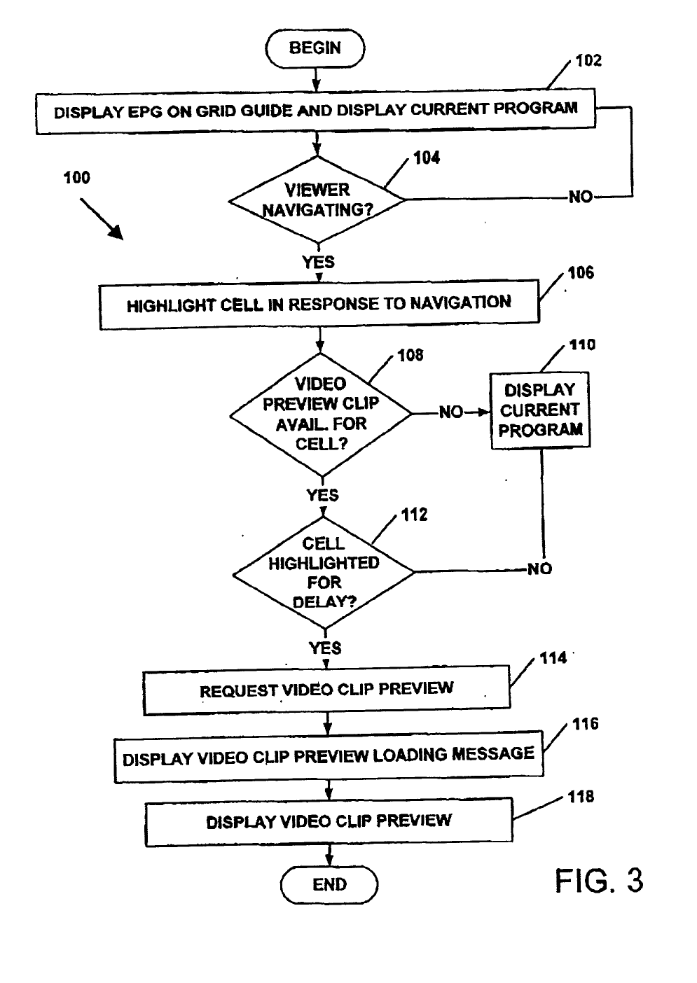

Referring now to FIG. 3, a flowchart of a process 100 for displaying video clip previews according to the present invention is shown. The process begins at Step 102 where the EPG grid guide 14 is displayed on the display screen 18 and the currently tuned programming is displayed in the smaller display window 20A. Step 102 is followed by Step 104 where a determination is made whether the viewer is navigating. If the determination is “NO,” the process 100 continues at Step 102 to display the EPG grid guide 14 and the currently tuned programming. However, if the determination is “YES,” Step 102 is followed by Step 106 at which a cell is highlighted in response to the navigation.

Step 106 is followed by Step 108 where a determination is made whether a video clip preview is available for the cell 16′ or in other words, for the program title. Furthermore, those cells of the program titled cells 16 that have a video clip preview 28 available for viewing may be colored, bordered or differently set apart in some manner to provide an indication to the consumer of such availability. If the determination is “NO,” Step 108 is followed by Step 110 where the small display window 20A continues to display the currently tuned programming. However, if the determination is “YES,” Step 108 is followed by Step 112 where a determination is made as to whether a cell is highlighted for a predetermined delay, such as, without limitation, one (1) second. If the determination is “NO,” Step 112 is followed by Step 110 where the small display window 20A continues to display the currently tuned programming. However, if the determination is “YES,” Step 112 is followed by Step 114 where a request for the video clip preview 28 is sent to a VOD server or a head end to launch the video clip preview 28.

In an alternate embodiment, the predetermined delay is substituted with a “One-Touch Display” format, where the viewer must actively request the video clip preview 28 such as by pressing a “Preview” button 36, described in detail below. In lieu of the “Preview” button 36, a virtual “Preview” button may be provided on the EPG grid guide 14 or some other means for selecting a preview option to display available video clip previews. Network operators, wishing to preserve network bandwidth by eliminating those requests that are not “real” may prefer this embodiment, at the expense of viewer convenience.

Step 114 is followed by Step 116 where a loading message or icon 24 is displayed notifying the viewer of the soon to be displayed video clip preview. Step 116 is followed by Step 118 where the video clip preview 28 is displayed on small display window 20A or optionally display window 20B wherein the audio track of the video clip preview 28 dominates and is heard. If only one display window 20A is provided, the loading message or icon 24 would be displayed on such window or in close proximity thereto.

In a still further alternate embodiment, a still image of an available video clip preview 28 can be displayed in the small display window 20B. In such alternative, the loading message or icon 24 may be optional. The loading message or icon 24 or alternately the still picture of the video clip preview provide a means to notify the viewer of the impending or imminent display of the video clip preview 28.

In view of the forgoing, the present invention provides for Video-Clip Previews on Demand by automatically launching a video clip preview 28 of a highlighted program titled cell 16′, after a predetermined delay. When the cell 16′ remains highlighted for said predetermined delay, it is assumed that the viewer wants to see the video clip preview 28 associated with the cell 16′, if a video clip preview 28 is available. Accordingly, the viewer does not have to make any selection (press any button) to display an available video clip preview. Since the viewer only needs to navigate and browse to highlight a cell of a program title to request an available video clip preview, such display process is defined as a “No-Touch Display” process. The “No-Touch Display” process launches the video clip preview 28 based on an assumption principle effectuated by the lapse of said predetermined delay from which a program titled cell 16′ is highlighted.

Referring now to FIGS. 1C and 2, the remote control 30 is provided with a “Preview” button 36, which allows the viewer to display the video clip preview 28 on the full screen display 18. Alternately, or in addition to the “Preview” button 36, the remote control 30 allows the viewer to navigate to the display window 20B and select the video clip preview 28. Upon selection of the displayed video clip preview 28, the video clip preview 28 is displayed on the full screen display 18. Thus, the present invention provides a “One-Touch Full Screen Display” option for viewing video clip previews.

In the embodiment where the “One-Touch Display” format is used the viewer would actively request the video clip preview 28 by pressing the “Preview” button 36. Thereafter, the video clip preview 28 is displayed on the full screen display 18.

In a VOD system the request for the video preview clip 28 would be sent to one or more VOD servers that reside on a local network, in relative proximity to the subscriber's home. Typically, VOD servers are used to serve up full-length feature films. Presently, VOD servers will serve a limited number of local subscribers, on the order of 1000 or so, with an assumed usage rate of about 10%. These servers may be specialized in design, to serve short-form video content, with simultaneous usage rate percentages approaching 90% during “prime time”.

When the video clip preview 28 is viewed as “full screen” format, the video clip preview 28 may be played from start to finish. Thereafter, display screen 18 automatically reverts back to display the EPG grid guide 14 or, alternately, a VOD/Jukebox ordering menu (NOT SHOWN). The latter is preferred for video preview clips 28 associated with ordered Movies.

In the preferred embodiment, the video clip preview 28 may be restricted to parental controls. Conventionally, EPG set-ups, such as the DirecTV user interface, have general purpose user profiles that do not need a password to use. Other user profiles require passwords. For example, a general “family” user profile may have restrictions in terms of content ratings to exclude certain content-rated, e.g., PG-13, R or X, programming. Accordingly, the video clip preview 28 associated with a PG-13, R or X rated program title would be excluded from these profiles. Alternatively, the EPG 12 may have a virtual “button” as part of the EPG grid guide 14 to activate recording of a program.

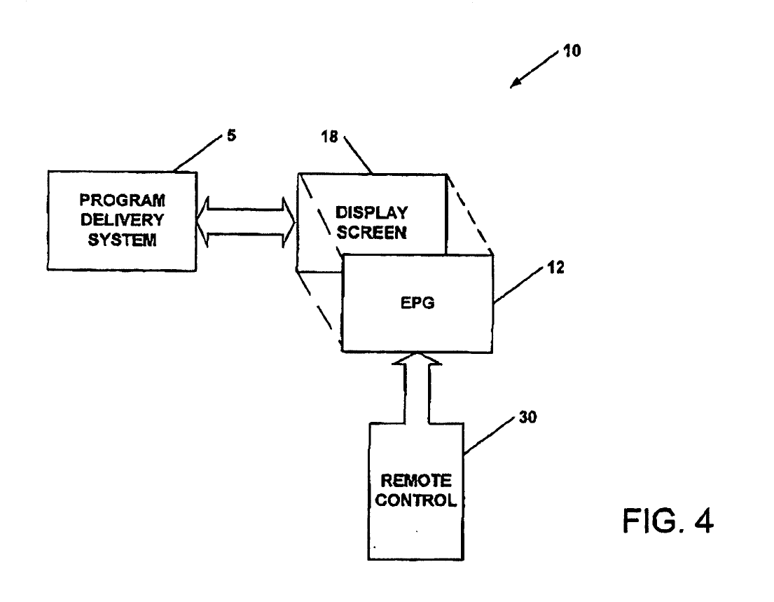

Referring now to FIG. 4 the interactive television or broadcast system 10 of the present invention includes remote control 30, display screen 18 and EPG 12 coupled to program delivery system 5. The program delivery system 5 may include a cable head end, satellite system and/or at least one VOD server. As can be appreciated, the display screen 18 includes a television, a PC monitor, or the like. Furthermore, the television may be cable ready or may have coupled thereto a cable box or other device for recording, ordering and interacting with the display screen 18.

The EPG 12 links the video clip preview 18 to the destination content (program) such that the destination content (program) can be viewed, ordered, recorded, or otherwise activated during the viewing of the video clip preview with which it is associated. The present invention embeds the expected commands, such as ordering protocols outlined by RTSP, into the context of the video clip preview 28.

In one embodiment, a number of video clip previews 28 can be pre-loaded to a hard disk drive within a Set Top Box device, to expedite the loading and playing of such previews, thus overcoming network congestion, etc.

Numerous modifications to and alternative embodiments of the present invention will be apparent to those skilled in the art in view of the foregoing description. Accordingly, this description is to be construed as illustrative only and is for the purpose of teaching those skilled in the art the best mode of carrying out the invention. Details of the structure may be varied substantially without departing from the spirit of the invention and the exclusive use of all modifications which come within the scope of the appended claims is reserved.

What is claimed is:

1. An interactive television/broadcast system comprising:
a display screen;
an electronic program guide (EPG) having at least one display window and a grid guide, the grid guide including a plurality of program titled cells displayed on the display screen, wherein the EPG displays a video-clip preview in the at least one display window on demand by automatically launching the video clip preview, after browsing and navigating through the grid guide to highlight a program titled cell, and remaining at the highlighted program titled cell for a predetermined delay.

2. The system according to claim 1, wherein the at least one display window includes a first display window for displaying a currently tuned program and a second display window for displaying the video clip preview wherein an audio track of the video clip preview is heard.

3. The system according to claim 2, wherein the second display window immediately displays a still image of the video clip preview if the video clip preview is available for the highlighted program titled cell prior to the display of the video clip preview.

4. The system according to claim 2, wherein the at least one display window displays a loading message or icon representative of an imminent video clip preview.

5. The system according to claim 2, further comprising a remote control device, the remote control device having means for navigating to the at least one display window and selecting the at least one display window to display the video clip preview on the display screen.

6. The system according to claim 1, further comprising a remote control device, the remote control device including:
navigation buttons for navigating and browsing through the grid guide; and,
a preview button for selecting to display the video clip preview on the display screen.

7. The system according to claim 6, wherein the remote control device further includes a record button for recording a program, the program having associated therewith a video clip preview adapted to be displayed on the at least one display window.

8. The system according to claim 1, wherein the EPG includes at least one user profile for excluding at least one content-rated program and associated video clip preview.

9. The system according to claim 1, wherein those program titled cells of the plurality of program titled cells having associated therewith a video clip preview are distinguished in appearance from other program titled cells not having an associated video clip preview to indicate the availability of the video clip preview.

10. A method of displaying video-clip previews on demand comprising the steps of:
displaying, on a display screen, an electronic program guide (EPG) having at least one display window and a grid guide, the grid guide including a plurality of program titled cells;
browsing through the grid guide;
during the browsing step, highlighting a program titled cell; and,
during the highlighting step, automatically displaying a video clip preview in the at least one display window when the highlighted programmed titled cell remains highlighted for a predetermined delay.

11. The method according to claim 10, wherein the at least one display window includes a first display window and a second display window; and
further comprising the steps of:
displaying in the first display window a currently tuned program; and
displaying in the second display window the video clip preview;
playing an audio track of the video clip preview simultaneously with the displaying step of the video clip preview.

12. The method according to claim 11, further comprising the step of prior to the step of displaying the video clip preview, displaying in the second display window a still image of the video clip preview if the video clip preview is available for the highlighted program titled cell.

13. The method according to claim 11, further comprising the step of displaying in the at least one display window a loading message or icon representative of an imminent video clip preview.

14. The method according to claim 11, further comprising the step of navigating to the at least one display window and selecting the at least one display window to display the video clip preview on the display screen.

15. The method according to claim 10, further comprising the step of selecting a preview button and displaying the video clip preview on the display screen.

16. The method according to claim 10, further comprising the step of selecting a record option for recording a program, wherein the program has associated therewith a video clip preview adapted to be displayed on the at least one display window and wherein the selecting may be performed during or after playing of the video clip preview.

17. The method according to claim 16, wherein the recording option may record the program associated with the video clip preview scheduled to be broadcast in the future or at a present time.

18. The method according to claim 10, further comprising the steps of:
determining a user profile for controlled scheduled programming of the EPG; and,
restricting the content rating of the controlled scheduled programming to exclude at least one content-rated type of programming and video clip previews associated with the at least one type of content-rated programming.

19. An interactive television/broadcast system comprising:
a display screen device having a display screen;
an electronic program guide (EPG) having at least one display window and a grid guide, the grid guide includes a plurality of program titled cells, displayed on the display screen, wherein the EPG displays a full-screen video clip preview on demand when selecting a preview option.

20. The system according to claim 19, further comprising a remote control device for controlling the display screen device and selecting the preview option.
